(19) United States
(12) Patent Application Publication
(10) Pub. No.: US 2025/0342466 A1
(43) Pub. Date: Nov. 6, 2025

(54) RENEWAL OF BLOCKCHAIN ASSETS BASED ON OPTIMIZATION OF BLOCKCHAIN PROCESSING

(71) Applicant: Unstoppable Domains, Inc., Las Vegas, NV (US)

(72) Inventors: Lisa Seacat DeLuca, Bozeman, MT (US); Hassan Ali, Chelsea, Quebec (CA)

(21) Appl. No.: 18/655,415

(22) Filed: May 6, 2024

(51) Int. Cl. G06Q 20/38

(52) U.S. Cl. CPC G06Q 20/389

(57) ABSTRACT

According to a present invention embodiment, a system for renewing a blockchain asset comprises one or more memories and at least one processor coupled to the one or more memories. The system monitors for a set of conditions associated with renewal of the blockchain asset. The set of conditions controls renewal processing and includes one or more blockchain processing values for performance of the renewal on a blockchain. The blockchain asset is renewed on the blockchain in response to satisfaction of the set of conditions. Embodiments of the present invention further include a method and computer program product for renewing a blockchain asset in substantially the same manner described above.

### TECHNICAL FIELD

Present invention embodiments relate to renewal of blockchain assets (e.g., a blockchain domain or domain name, etc.) on a blockchain based on optimization of blockchain processing (or gas). For example, an embodiment of the present invention enables renewals of the blockchain assets on blockchains based on preferences for the renewals. The preferences may indicate conditions pertaining to blockchain processing or gas to optimize blockchain processing for the renewals.

### BACKGROUND

### Discussion of the Related Art

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks. Some Web3 domains expire in a similar fashion as a traditional Web2 (or Internet Corporation for Assigned Names and Numbers (ICANN)) domain, and need to be periodically renewed to be maintained. The renewal period may be yearly, or decomposed into smaller periods of time.

However, on-chain (or Web3) renewals typically incur a gas or processing fee for blockchain processing since the renewal operation is a blockchain transaction. Since gas values fluctuate based on blockchain processing conditions, a renewal may have a significantly higher cost based on the hour or time of day in which the corresponding blockchain transaction is performed.

### SUMMARY

According to one embodiment of the present invention, a system for renewing a blockchain asset comprises one or more memories and at least one processor coupled to the one or more memories. The system monitors for a set of conditions associated with renewal of the blockchain asset. The set of conditions controls renewal processing and includes one or more blockchain processing values for performance of the renewal on a blockchain. The blockchain asset is renewed on the blockchain in response to satisfaction of the set of conditions. Embodiments of the present invention further include a method and computer program product (e.g., including one or more computer readable media with instructions executable by one or more processors) for renewing a blockchain asset in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of providing preferences for renewing blockchain assets according to an embodiment of the present invention.

FIG. 4 is a flowchart of a method of renewing blockchain assets according to an embodiment of the present invention.

FIG. 5 is a flowchart of a method of renewing blockchain assets when preferences for renewal fail to be satisfied according to an embodiment of the present invention.

FIG. 6 is a graphical illustration of an example user interface for renewing a blockchain asset according to an embodiment of the present invention.

FIG. 7 is a graphical illustration of an example user interface for providing preferences for renewing blockchain assets according to an embodiment of the present invention.

FIG. 8 is a graphical illustration of an example user interface for providing information and requesting an override according to an embodiment of the present invention.

### DETAILED DESCRIPTION

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks. Some Web3 domains expire in a similar fashion as a traditional Web2 (or Internet Corporation for Assigned Names and Numbers (ICANN)) domain, and need to be periodically renewed to be maintained. The renewal period may be yearly, or decomposed into smaller periods of time.

However, on-chain (or Web3) renewals typically incur a gas or processing fee for blockchain processing since the renewal operation is a blockchain transaction. Since gas values fluctuate based on blockchain processing conditions, a renewal may have a significantly higher cost based on the hour or time of day in which the corresponding blockchain transaction is performed.

Accordingly, present invention embodiments relate to renewal of blockchain assets (e.g., a blockchain domain or domain name, etc.) on blockchains based on optimization of blockchain processing (or gas). In other words, an embodiment of the present invention provides gas value based blockchain execution for tokens with an expiration. For example, an embodiment of the present invention enables renewals of the blockchain assets based on preferences for the renewals. The preferences may indicate conditions pertaining to blockchain processing or gas in order to optimize blockchain processing for the renewal. In other words, present invention embodiments apply the preferences to optimize blockchain processing for the renewal (e.g., the preferences identify conditions for peak or high processing performance of the blockchain to rapidly process the renewal, etc.). A blockchain asset may include any digital asset or item that identifies, is associated with, or includes objects stored on a blockchain, such as a set of records, an object that points to a set of records, non-fungible token (NFT), non-fungible token (NFT) or blockchain domain names, a fungible token, a wallet address, etc.

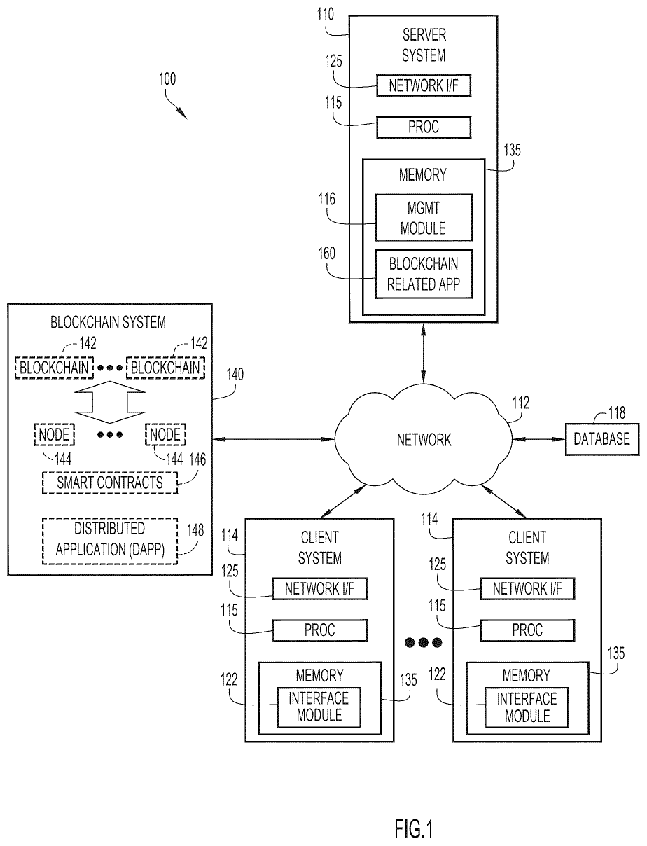

An example environment 100 for use with present invention embodiments is illustrated in FIG. 1. Specifically, environment 100 includes one or more server systems 110, one or more client or end-user systems 114, and one or more blockchain systems 140 each implementing and maintaining at least one corresponding blockchain 142. Server systems 110, client systems 114, and/or blockchain systems 140 may be remote from each other and communicate over a network 112. The network may be implemented by any number of suitable communications media (e.g., wide area network (WAN), local area network (LAN), Internet, Intranet, etc.). Alternatively, server systems 110, client systems 114, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via client system 114, and/or may be of the form of an Application Programming Interface (API) to perform blockchain asset management (e.g., register and/or manage blockchain assets, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing and accessing blockchain assets. The interface module may include any conventional or other browser to access server systems 110 and blockchain systems 140.

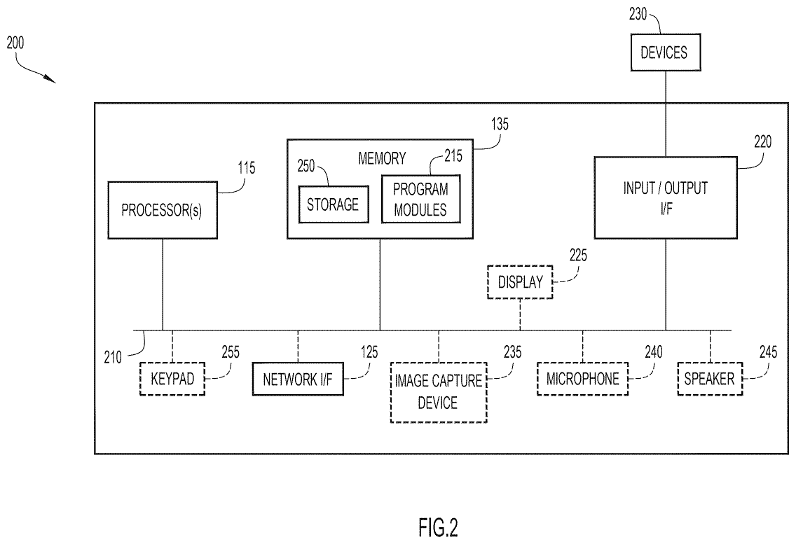

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more smart contracts 146 and one or more decentralized or distributed applications (dApps) 148 to perform various operations (e.g., financial or other transactions or operations related to a blockchain, renewal of blockchain assets, etc.). Blockchain assets may be associated with the same and/or various different blockchains.

Interface module 122 of client systems 114 may further provide a graphical user (e.g., GUI, etc.) or other interface (e.g., command line prompts, menu screens, etc.) that enables users to access decentralized applications (dApps) 148 on blockchain systems 140 for performing various operations (e.g., financial or other transactions or operations related to a blockchain, renewal of blockchain assets, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a renewal request, renewal results, etc.).

Server systems 110 further include one or more blockchain related applications 160 for performing various operations (e.g., transactions or operations related to a blockchain, access blockchain asset information, renew blockchain assets, etc.). Management module 116 and blockchain related applications 160 may be on the same or different server systems 110. The blockchain related application may process requests from any entities (e.g., user, application, service, computing or other device, etc.).

A database or off-chain storage system 118 may store various information for a blockchain asset and/or renewal (e.g., blockchain asset information, mappings of blockchain assets to blockchains, renewal preferences, blockchain domain content, etc.). The database system may be implemented by any conventional or other database or off-chain storage unit (e.g., Interplanetary File System (IPFS), etc.), may be local to or remote from server systems 110, client systems 114, and/or blockchain systems 140, and may communicate via any appropriate communication medium (e.g., local area network (LAN), wide area network (WAN), Internet, hardwire, wireless link, Intranet, etc.).

Server systems 110 and client systems 114 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, smart contracts 146, decentralized applications (dApps) 148, and blockchain related applications 160 may include one or more modules or units to perform the various functions of present invention embodiments described below. The various modules (e.g., management module 116, interface module 122, blockchain related applications 160, etc.) may be implemented by any combination of any quantity of software and/or hardware modules or units, and may reside within memory 135 of the server and/or client systems for execution by a corresponding processor 115. The various modules of the blockchain (e.g., smart contracts 146, decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, blockchain software (e.g., smart contracts 146, decentralized applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 146) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

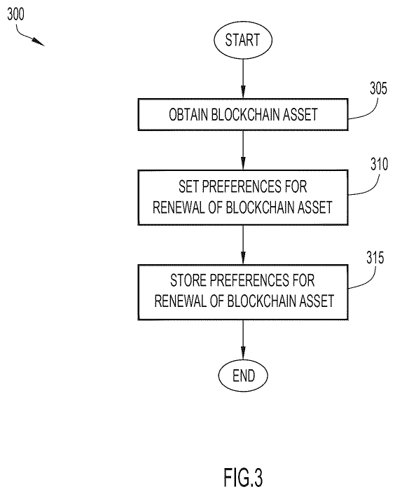

A method 300 of providing preferences for renewing blockchain assets (e.g., via management module 116, blockchain related application 160, server system 110, client system 114, and/or blockchain system 140) according to an embodiment of the present invention is illustrated in FIG. 3. By way of example, method 300 is described with respect to a blockchain domain. However, preferences may be provided for any blockchain asset in substantially the same manner described below.

Initially, a user may obtain a blockchain asset (e.g., via management module 116, etc.) at operation 305. The blockchain asset may be obtained by a new registration, purchase, or transfer. The blockchain asset may require renewal after expiration of time intervals (e.g., one or more years, months, etc.). For example, the user may register a blockchain domain (or domain name) (e.g., via management module 116). The blockchain domain name may include any quantity of terms, words, tokens, or arrangements of any quantity of any types of elements (e.g., alphanumeric or other characters, symbols, numbers, etc.). By way of example, the blockchain domain name may include a name portion and an optional extension (preferably indicating a corresponding blockchain) (e.g., “name.e1”, etc.). The name portion and extension may each include any quantity of terms, words, tokens, or arrangements of any quantity of any types of elements (e.g., alphanumeric or other characters, symbols, numbers, etc.).

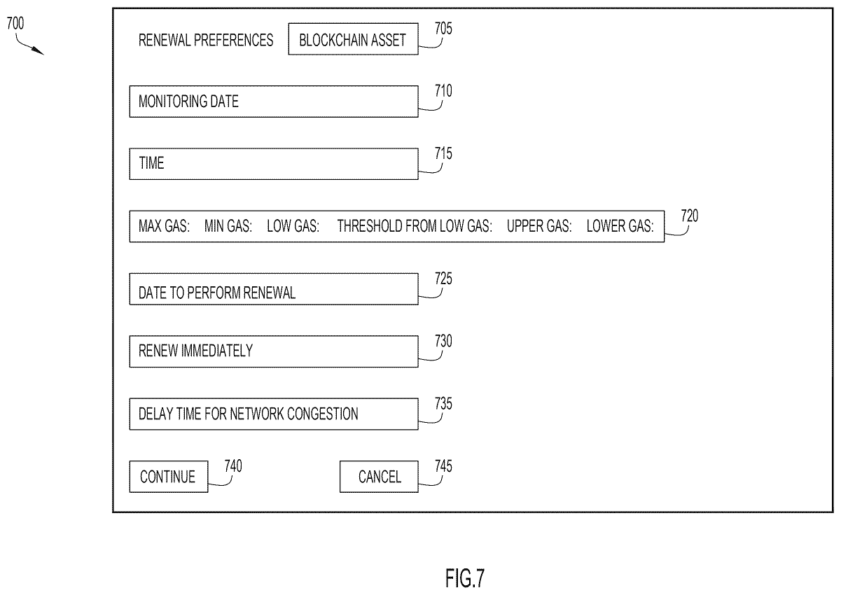

Preferences or conditions for automatically renewing the blockchain asset may be set at operation 310. The preferences or conditions for renewal of the blockchain asset may be obtained in any manner. For example, the preferences or conditions may be provided by a user on a user interface (e.g., FIG. 7) provided by interface module 122 of a client system 114, and transferred to a decentralized application (dApp) 148 or a blockchain related application 160 for storage. Further, the preferences or conditions may be preconfigured or updated. The preferences or conditions may include various times, gas values, and/or other attributes for triggering automatic renewal of the blockchain asset. The preferences may indicate conditions pertaining to blockchain processing or gas in order to optimize blockchain processing for the renewal. The preferences are applied to optimize blockchain processing for the renewal (e.g., the preferences identify conditions for peak or high processing performance of the blockchain to rapidly process the renewal, etc.).

By way of example, preferences for renewal of a blockchain asset may include: a date (e.g., a date or time period prior to expiration of a blockchain asset to initiate identifying optimal blockchain processing or most affordable renewal gas values, etc.); a time of day (e.g., a time of day to calculate renewal costs (e.g., 3 AM or other times when the network tends to be slower, thereby providing optimal blockchain processing for the renewal, etc.), gas values (e.g., in gwei, dollars or other currency, etc.) that may include a maximum gas value (e.g., 50 gwei, etc.), a minimum gas value, a low value (e.g., from a time period (e.g., a week/month/day low, etc.), within a threshold amount from a low value, etc.; a time to process the renewal (e.g., for ignoring the optimization within a final drop dead time regardless of blockchain processing or gas values, when the preferences weren't met and the asset expiration is within an hour/day/week, etc.); renew immediately (e.g., may be used for a manual approach and/or to force the renewal, etc.); a delay period (e.g., when high network congestion is detected, renewal is delayed by a predefined time period or until blockchain processing or gas values stabilize, etc.); upper and lower blockchain processing or gas values for a time period (e.g., set an optimal range of upper/lower limits for a time period for blockchain processing based on a machine learning model, where renewal may be initiated when blockchain processing or gas values are within this range during the time period, etc.).

The preferences may be provided by a user or suggested by the system. The user may overwrite or modify the preferences suggested by the system. The preferences may initially be provided at the time of obtaining the blockchain asset and/or entered or updated over time. By way of example, a machine learning model may be employed to determine preferences for optimal blockchain processing for the renewal, such as the upper and lower blockchain processing or gas values for a time period. The machine learning model may be implemented by any conventional or other machine learning models (e.g., mathematical/statistical, classifiers, feed-forward, recurrent, convolutional or other neural networks, etc.). For example, neural networks may include an input layer, one or more intermediate layers (e.g., including any hidden layers), and an output layer. Each layer includes one or more neurons, where the input layer neurons receive input (e.g., image data, feature vectors of images, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of inputs and corresponding known outputs, where the neural network attempts to produce the provided or known output (or classification) and uses an error from the output (e.g., difference between produced and known outputs) to adjust weight (and bias) values (e.g., via backpropagation or other training techniques).

In this example case, the machine learning may be performed using a training set of network congestion or other attributes affecting blockchain processing or gas values over time as input and known corresponding classifications (or upper and lower blockchain processing or gas values over the time period providing optimal blockchain processing) as output, where the neural network attempts to produce the provided output (or upper and lower blockchain processing or gas values providing optimal blockchain processing). The blockchain processing or gas values for training the neural network may be obtained from any conventional or other tools monitoring and providing blockchain processing (or gas) values and/or analytics over time.

In an embodiment, feature vectors may be based on, or extracted from, the attributes and used for the training set as input, while the corresponding known classifications may be used for the training set as known output. A feature vector may include any suitable features (e.g., congestion, network throughput, processing load, etc.).

The output layer of the neural network indicates a classification (e.g., upper and lower blockchain processing or gas values for optimal blockchain processing, etc.) for input data. By way of example, the classes used for the classification may include classes associated with upper and lower blockchain processing or gas values. The output layer neurons may provide a classification that indicates upper and lower blockchain processing or gas values, and indicate a probability for the input data being within a corresponding class (e.g., probability for the upper and lower blockchain processing or gas values, etc.). The class or blockchain processing (or gas) values associated with the highest probability is preferably selected as the class or result for the input data. The attribute information may be provided to the neural network, where the neural network indicates upper and lower blockchain processing or gas values for optimal blockchain processing of the renewal. The neural network or other machine learning model may be trained in substantially the same manner described above to suggest other renewal preferences.

Once the preferences are obtained, the preferences are stored at operation 315. The preferences may be stored on a blockchain or on-chain (e.g., blockchain system 140, etc.), off-chain (e.g., database system 118, etc.), or in a combination of on-chain and off-chain storage. When the preferences are stored on-chain, they may be stored as part of the data associated with a blockchain asset.

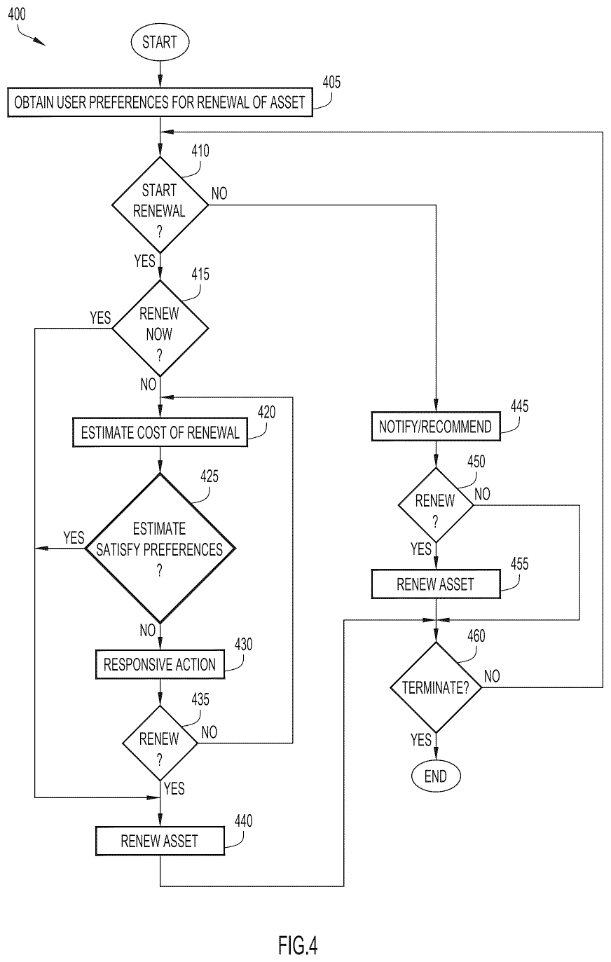

A method 400 of renewing blockchain assets (e.g., via management module 116, smart contract 146, decentralized application (dApp) 148, blockchain related application 160, server system 110, client system 114, and/or blockchain system 140) according to an embodiment of the present invention is illustrated in FIG. 4. By way of example, method 400 is described with respect to a blockchain asset including a blockchain domain. However, any blockchain asset may be renewed in substantially the same manner described below.

Initially, a user obtains a blockchain asset as described above (e.g., via management module 116, etc.). The blockchain asset may be obtained by a new registration, purchase, or transfer. The blockchain asset may require renewal after expiration of time intervals (e.g., one or more years, months, etc.). For example, the user may register a blockchain domain (or domain name) (e.g., via management module 116). The blockchain domain name may include any quantity of terms, words, tokens, or arrangements of any quantity of any types of elements (e.g., alphanumeric or other characters, symbols, numbers, etc.). For example, the blockchain domain name may include a name portion and an optional extension (preferably indicating a corresponding blockchain) (e.g., “name.e1”, etc.). The name portion and extension may each include any quantity of terms, words, tokens, or arrangements of any quantity of any types of elements (e.g., alphanumeric or other characters, symbols, numbers, etc.).

The preferences or conditions for renewal of the blockchain asset are obtained at operation 405 from the appropriate storage (e.g., on-chain storage, off-chain storage, a combination of on-chain and off-chain storage, etc.). This may be accomplished by management module 116, decentralized application 148 (dApp), and/or blockchain related application 160 retrieving the information based on the blockchain asset (e.g., name, wallet address, etc.) and depending on the location of the preferences (e.g., on-chain storage, off-chain storage, a combination of on-chain and off-chain storage, etc.). The preferences or conditions may include various times, blockchain processing or gas values, and/or or other attributes for triggering automatic renewal of the blockchain asset.

The system (e.g., management module 116, decentralized application (dApp) 148, and/or blockchain related application 160) monitors for occurrence of preferences or conditions initiating renewal of the blockchain asset. For example, the system basically provides an automatic renewal service that tracks the date and/or time for monitoring conditions for renewal of the blockchain asset.

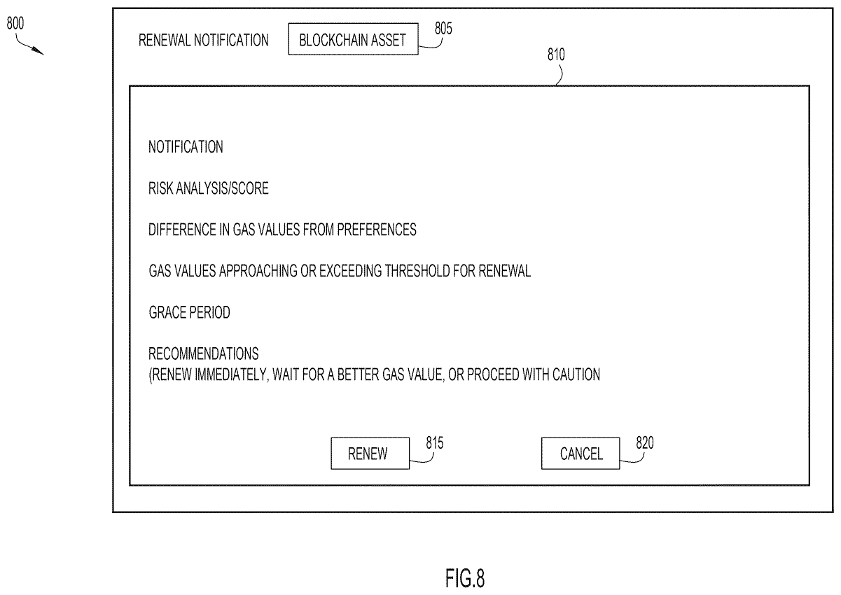

When preferences or conditions for initiating the renewal of the blockchain asset are not satisfied (e.g., not within a time interval, unacceptable blockchain processing or gas values, etc.) as determined at operation 410, the user is notified and a recommendation may be provided at operation 445. For example, the user may be notified (e.g., via a user interface 800 of FIG. 8 described below that is provided by interface module 122 of client system 114) when blockchain processing or gas values are approaching or exceeding the user set threshold for renewal (allowing for adjustments), and/or when a blockchain asset enters a grace period for renewing (e.g., .ETH domains, etc.). In addition, recommendations may be provided on whether to renew immediately, wait for a better blockchain processing or gas value, or to proceed with caution.

Once the notifications and/or recommendations are provided, the user may initiate renewal of the blockchain asset in response to the notifications and/or recommendations (e.g., actuate an actuator on user interface 800 of FIG. 8 described below providing the notification or recommendation, etc.). When the user initiates renewal of the blockchain asset as determined at operation 450, the blockchain asset is renewed at operation 455. This may be accomplished by conducting a transaction on the blockchain (e.g., via management module 116, smart contract 146, decentralized application (dApp) 148, and/or blockchain related application 160) to renew the blockchain asset. The transaction may include payment to renew the blockchain asset (e.g., a cryptocurrency or other blockchain transaction from a user wallet account, etc.). The renewal of the blockchain asset may be pooled or joined with other user owned blockchain assets that have met their preferences or conditions to optimize blockchain processing or gas.

The process repeats from operation 410 to determine when to initiate renewal of the blockchain asset until termination of the automatic renewal service as determined at operation 460.

When preferences or conditions for initiating the renewal of the blockchain asset are satisfied (e.g., within a time interval, acceptable blockchain processing or gas values, etc.) as determined at operation 410, the renewal process is initiated. Initially, when a preference or condition indicates to immediately renew the blockchain asset as determined at operation 415, the blockchain asset is renewed at operation 440. This may be accomplished by conducting a transaction on the blockchain (e.g., via management module 116, smart contract 146, decentralized application (dApp) 148, and/or blockchain related application 160) to renew the blockchain asset in substantially the same manner described above. For example, the renewal may be accomplished by conducting a blockchain transaction (from a user wallet account) on the blockchain (e.g., via management module 116, smart contract 146, decentralized application (dApp) 148, and/or blockchain related application 160) to renew the blockchain asset. The renewal of the blockchain asset may be pooled or joined with other user owned blockchain assets that have met their preferences or conditions to optimize blockchain processing or gas.

When the preferences do not indicate an immediate renewal as determined at operation 415, the system (e.g., management module 116, decentralized application (dApp) 148, and/or blockchain related application 160) determines satisfaction of the preferences or conditions in order to renew the blockchain asset. In particular, an estimate of the renewal costs (e.g., including blockchain processing, renewal fees, etc.) for maintaining ownership of the blockchain asset is determined by the system at operation 420. When the estimate of renewal costs satisfies the preferences or conditions (e.g., blockchain processing or gas values, etc.) as determined at operation 425, the blockchain asset is renewed at operation 440 in substantially the same manner described above. For example, the renewal may be accomplished by conducting a transaction (from a user wallet account) on the blockchain (e.g., via management module 116, smart contract 146, decentralized application 148, and/or blockchain related application 160) to renew the blockchain asset. The renewal of the blockchain asset may be pooled or joined with other user owned blockchain assets that have met their preferences or conditions to optimize gas or processing.

When the estimate fails to satisfy the preferences or conditions as determined at operation 425, a responsive action may be performed at operation 430. The responsive action may include a delay or an override by the user to renew the blockchain asset as described below.

When the responsive action enables renewal of the blockchain asset as determined at operation 435, the blockchain asset is renewed at operation 440 in substantially the same manner described above. For example, the renewal may be accomplished by conducting a transaction (from a user wallet account) on the blockchain (e.g., via management module 116, smart contract 146, decentralized application 148, and/or blockchain related application 160) to renew the blockchain asset. The renewal of the blockchain asset may be pooled or joined with other user owned blockchain assets that have met their preferences or conditions to optimize gas or processing.

When the responsive action does not enable renewal of the blockchain asset as determined at operation 435, the above process is repeated from operation 420 to determine a new estimate of renewal costs for compliance with the preferences or conditions in substantially the same manner described above (e.g., after a delay, etc.).

Once the asset is renewed at operation 440, the process repeats from operation 410 to determine when to initiate a next renewal of the blockchain asset until the automatic renewal service terminates as determined at operation 460. The system may track preferences or conditions for automatically renewing various blockchain assets of users in substantially the same manner described above.

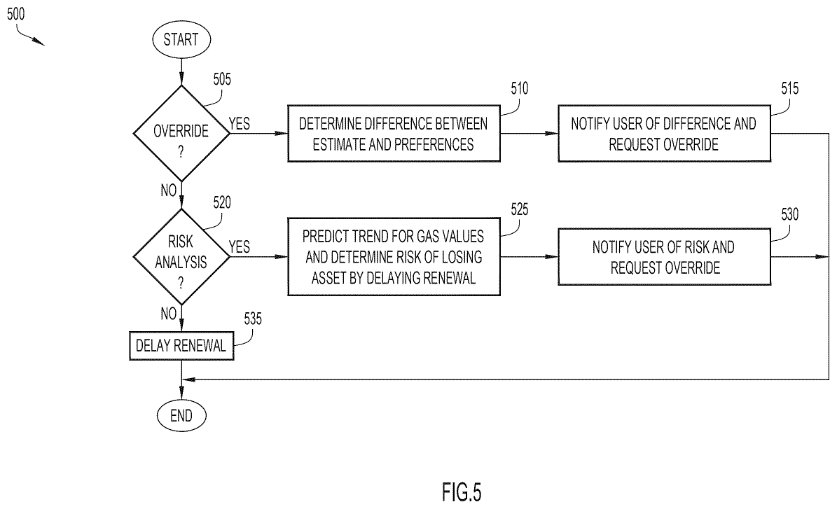

When the estimate of renewal costs does not satisfy the preferences or conditions, various actions may be performed to establish compliance. A method 500 of renewing blockchain assets when preferences for renewal fail to be satisfied (e.g., via management module 116, smart contract 146, decentralized application (dApp) 148, blockchain related application 160, server system 110, client system 114, and/or blockchain system 140) according to an embodiment of the present invention is illustrated in FIG. 5. This may correspond to operation 430 of FIG. 4. By way of example, method 500 is described with respect to a blockchain asset including a blockchain domain. However, any blockchain asset may be renewed in substantially the same manner described below.

Initially, the preferences or conditions for initiating renewal of the blockchain asset are satisfied, and the estimate for renewal costs (e.g., including blockchain processing, renewal fees, etc.) is produced in substantially the same manner described above. However, the estimate may fail to satisfy the preferences or conditions for renewing the blockchain asset. For example, the estimate may include blockchain processing or gas values beyond the values specified in the preferences or conditions. In this case, various actions may be performed to enable the renewal.

For example, a user may override the conditions or preferences to initiate renewal of the blockchain asset. When an override is employed as determined at operation 505, the system (e.g., management module 116, decentralized application (dApp) 148, and/or blockchain related application 160) determines a difference between a preference or condition and the estimate at operation 510. By way of example, the difference may include a difference between the blockchain processing or gas value of the estimate and blockchain processing or gas values of the preferences or conditions. A notification is provided to the user (e.g., via user interface 800 of FIG. 8 described below that is provided by interface module 122 and client system 114) indicating the difference and requesting an override at operation 515. When the user indicates to override (e.g., actuate a renew or override actuator on user interface 800 as described below, etc.), the renewal of the blockchain asset is performed in substantially the same manner described above (e.g., at operations 435 and 440 of FIG. 4).

Further, a risk analysis may be performed to inform the user of a risk of losing the blockchain asset with respect to delaying renewal until satisfaction of the preferences or conditions. In other words, the system (e.g., management module 116, decentralized application (dApp) 148 and/or blockchain related application 160) determines the risk of waiting with respect to losing the blockchain asset for failing to renew. When a risk analysis is employed as determined at operation 520, the system predicts a trend for gas values and determines a risk of losing the blockchain asset due to delaying renewal at operation 525. For example, a machine learning model may be used to determine the likelihood or probability of gas values increasing and/or decreasing (e.g., probability of gas value trends, etc.). The machine learning model may be implemented by any conventional or other machine learning models (e.g., mathematical/statistical, classifiers, feed-forward, recurrent, convolutional or other neural networks, etc.).

By way of example, the machine learning model may be implemented by a neural network as described above. In this example case, the machine learning may be performed using a training set of blockchain processing or gas values and network congestion or other attributes over a time period as input and known corresponding classifications (increasing or decreasing gas values over the time period) as output, where the neural network attempts to produce the provided output (or an indication of increasing or decreasing gas values). The blockchain processing or gas values for training the neural network may be obtained from any conventional or other tools monitoring and providing blockchain processing (or gas) values and/or analytics over time

In an embodiment, feature vectors may be based on, or extracted from, the attributes and used for the training set as input, while the corresponding known classifications may be used for the training set as known output. A feature vector may include any suitable features (e.g., congestion, network throughput, processing load, etc.).

The output layer of the neural network indicates a classification (e.g., increasing or decreasing blockchain processing (or gas) values) for input data. By way of example, the classes used for the classification may include a class associated with increasing blockchain processing or gas values and a class associated with decreasing blockchain processing or gas values. The output layer neurons may provide a classification that indicates increasing or decreasing blockchain processing (or gas) values, and indicate a probability for the input data being within a corresponding class (e.g., probability or likelihood for increasing or decreasing blockchain processing (or gas) values, etc.). The class associated with the highest probability is preferably selected as the class or result for the input data. The blockchain processing (or gas) value and attribute information may be provided to the neural network, where the neural network indicates the trend (increasing or decreasing) for the blockchain processing or gas values.

The system (e.g., management module 116, decentralized application (dApp) 148 and/or blockchain related application 160) determines a risk of losing the blockchain asset (not renewing) due to deferring renewal based on the trend of blockchain processing (or gas) values from the machine learning model and closeness of the blockchain processing or gas values to the preferences or conditions. For example, when the blockchain processing or gas value is near a maximum value of the preferences or conditions and there is a high likelihood of the blockchain processing or gas values increasing (e.g., based on the probability from the neural network, etc.), the risk of losing the blockchain asset is high since the blockchain processing or gas value is likely to exceed the blockchain processing or gas value of the preferences or conditions and prevent renewal. The risk may be indicated by a risk score determined based on a combination of the likelihood of the trend (e.g., probability from the neural network, etc.) and the difference between current gas values and the gas values of the preferences or conditions.

Alternatively, a risk machine learning model may be used to determine the risk score. The risk machine learning model may be implemented by any conventional or other machine learning models (e.g., mathematical/statistical, classifiers, feed-forward, recurrent, convolutional or other neural networks, etc.).

By way of example, the risk machine learning model may be implemented by a neural network as described above. In this example case, the machine learning may be performed using a training set of blockchain processing or gas values (and/or trends from the machine learning model described above) and network congestion or other attributes over a time period as input and known corresponding classifications (e.g., occurrence or absence of renewals over the time period) as output, where the neural network attempts to produce the provided output (or an indication of occurrence or absence of the renewal).

In an embodiment, feature vectors may be based on, or extracted from, the attributes and used for the training set as input, while the corresponding known classifications may be used for the training set as known output. A feature vector may include any suitable features (e.g., congestion, network throughput, processing load, etc.).

The output layer of the neural network indicates a classification (e.g., occurrence of a renewal, absence of a renewal) for input data. By way of example, the classes used for the classification may include a class associated with occurrence of a renewal and a class associated with absence of a renewal. The output layer neurons may provide a classification that indicates occurrence or absence of a renewal, and indicate a probability for the input data being within a corresponding class (e.g., probability or likelihood for the renewal or absence of a renewal). The probability or likelihood may represent the risk score. For example, the probability of absence of a renewal may represent the risk score for losing the blockchain asset by failing to renew. The blockchain processing or gas value (or trends from the machine learning model described above) and attribute information may be provided to the neural network, where the neural network indicates the risk score (e.g., probability of renewal or absence of a renewal, etc.).

In addition, the risk analysis may be performed based on analytics and trends obtained from any conventional or other tools monitoring and providing blockchain processing (or gas) values, analytics, and trends over time. For example, when the blockchain processing or gas value is near a maximum value of the preferences or conditions and there is an increasing trend indicated by the analytics, the risk of losing the blockchain asset is high since the blockchain processing or gas value is likely to exceed the blockchain processing or gas value of the preferences or conditions and prevent renewal. The risk may be indicated by a risk score determined based on a combination of the change in values indicated by the trend and the difference between current blockchain processing or gas values and the blockchain processing or gas values of the preferences or conditions.

A notification is provided to the user (e.g., on user interface 800 of FIG. 8 described below that is provided via interface module 122 and client system 114) indicating a risk score (or risk of losing the blockchain asset) (e.g., a percentage likelihood (e.g., 0-100%) that the blockchain asset may not be renewed, etc.) and requesting an override at operation 530. When the user indicates to override (e.g., via actuating a renew or override actuator on user interface 800 as described below, etc.), the renewal of the blockchain asset is performed in substantially the same manner described above (e.g., at operations 435 and 440 of FIG. 4).

In addition, the system (e.g., management module 116, decentralized application (dApp) 148 and/or blockchain related application 160) may wait for expiration of a time period, and determine a new estimate for comparison with the preferences or conditions. When a delay is employed (instead of an override and risk analysis as determined at operations 505 and 520), the system waits for expiration of a time period at operation 535 and calculates a new estimate for comparison with the preferences or conditions in substantially the same manner described above (e.g., for operations 435 and 420 of FIG. 4).

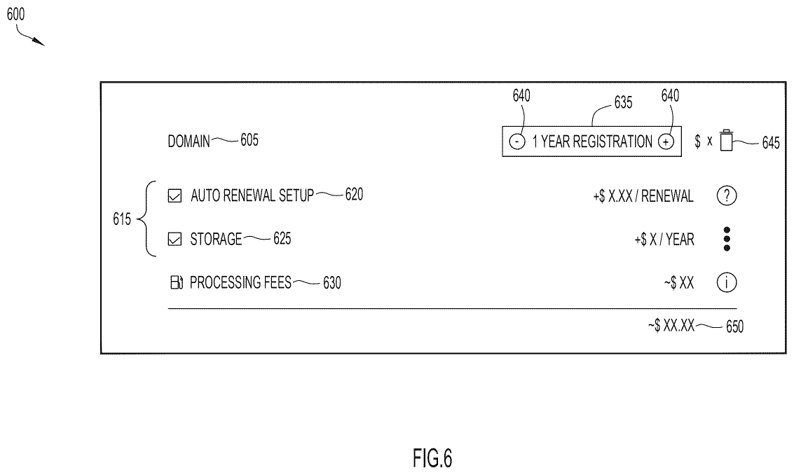

An example user interface 600 for renewing a blockchain asset according to an embodiment of the present invention is illustrated in FIG. 6. By way of example, user interface 600 represents renewal settings for a blockchain domain 605, and includes selectable settings 615, processing fees 630, registration time interval 635 and adjustment actuators 640, delete actuator 645, and total fees 650. Selectable settings 615 enable selection of automatic renewal 620 and storage 625, and may be selected via any input mechanisms (e.g., checkbox, etc.). When automatic renewal 620 is selected or enabled, blockchain domain 605 is automatically renewed according to corresponding preferences or conditions in substantially the same manner described above. The preferences or conditions may be preconfigured, determined/adjusted by the system, or entered by a user on a user interface (e.g., FIG. 7). Selecting or enabling storage 625 provides for storage of the blockchain asset on a blockchain. A fee may be charged for automatic renewal and/or storage (as shown in FIG. 6).

Processing fees 630 represent the costs of blockchain processing or gas for conducting the renewal transaction on the blockchain. Registration time interval 635 indicates a time interval for renewing blockchain asset 605 (or the time which a registration remains valid), and may be adjusted via adjustment actuators 640 (e.g., increase and decrease actuators). The fee for the registration is provided adjacent an actuator 640. Delete actuator 645 enables the renewal configuration to be deleted, while total fees 650 provides a total fee for the renewal. In this example case, the renewal is automatically performed at the indicated fees based on the preferences or conditions (e.g., at a time to optimize blockchain processing, etc.).

An example user interface 700 for providing preferences for renewing blockchain assets according to an embodiment of the present invention is illustrated in FIG. 7. By way of example, user interface 700 represents renewal settings for a blockchain asset 705, and may be presented after selection of automatic renewal (e.g., on user interface 600 of FIG. 6), registration, purchase, and/or transfer of the blockchain asset (e.g., via management module 116, etc.).

User interface 700 may include a monitoring date field 710, a time field 715, a gas field 720, a renewal performance date field 725, a renew immediately field 730, and a delay field 735. Monitoring date field 710 indicates a date or time period prior to expiration of a blockchain asset to initiate identifying optimal blockchain processing (or most affordable renewal gas values). Time field 715 indicates a time of day to calculate renewal costs (e.g., 3 AM or other times when the network tends to be slower, thereby providing optimal blockchain processing for the renewal, etc.). Gas field 720 indicates gas values (e.g., in gwei, dollars or other currency, etc.). The gas values may include a maximum gas value (e.g., 50 gwei, etc.), a minimum gas value, a low value (e.g., from a time period (e.g., a week/month/day low, etc.), within a threshold amount from a low value, and/or upper and lower gas values for a time period (e.g., upper/lower limits for a time period for optimal blockchain processing based on a machine learning model, etc.). Renewal performance date field 725 indicates a time to process the renewal. This time ignores the blockchain processing (or gas) optimization and provides a final drop dead time or date regardless of blockchain processing or gas values (e.g., when the preferences weren't met and the asset expiration is within an hour/day/week, etc.). Renew immediately field 730 may be used for a manual approach and/or to force the renewal, or to simply renew at a desired time. The field may include checkboxes or other actuators to enable or disable immediate renewal. Delay field 735 indicates a delay period. For example, when high network congestion is detected, renewal may be delayed by a predefined or entered time period, or until blockchain processing or gas values stabilize. The field may include checkboxes or other actuators to select the type of delay (e.g., predefined time period, entered time period, until gas values stabilize, etc.).

A user and/or the system may determine and enter desired selections in one or more fields of user interface 700 to provide or modify preferences or conditions for renewal of the blockchain asset. The user may actuate a continue actuator 740 to save and apply the preferences to renewals, or actuate a cancel actuator 745 to disregard the entries.

An example user interface 800 for providing information and requesting an override according to an embodiment of the present invention is illustrated in FIG. 8. By way of example, user interface 800 provides notifications concerning automatic renewal of a blockchain asset 805. User interface 800 may be presented after determining that preferences or conditions for automatic renewal are not satisfied.

User interface 800 may include a notification area 810 that provides information concerning renewal of blockchain asset 805. For example, notification area 810 may indicate a risk analysis or score of losing the blockchain asset due to deferral of renewal, difference in current blockchain processing or gas values from blockchain processing or gas values of the preferences or conditions, when blockchain processing or gas values are approaching or exceeding the user set threshold for renewal (allowing for adjustments), when a blockchain asset enters a grace period for renewing, etc. In addition, recommendations may be provided on whether to renew immediately, wait for a better gas value, or to proceed with caution. This enables a user to override the preferences or conditions, and initiate immediate renewal of blockchain asset 805.

The user may actuate renew actuator 815 to override the preferences or conditions for automatic renewal and immediately renew the blockchain asset based on the information in the notification area 810 (e.g., the risk of losing the blockchain asset is high, the difference between the current blockchain processing or gas values and preferences or conditions is low, etc.). The blockchain asset may be renewed in substantially the same manner described above. Alternatively, the user may actuate cancel actuator 820 to continue automatic renewal in accordance with the preferences or conditions based on the information in notification area 810 (e.g., the risk of losing the blockchain asset is low, the difference between the current blockchain processing or gas values and the preferences or conditions is high, etc.).

Present invention embodiments may provide various technical and other advantages. For example, a present invention embodiment provides optimized blockchain processing for automatic renewals of blockchain assets. The present invention embodiment applies preferences that identify conditions for peak or high processing performance of the blockchain to rapidly process the renewal. The preferences for optimal blockchain processing may be determined by present invention embodiments using machine learning models that may continuously update preferences (e.g., upper, lower, and/or other gas values, etc.) over time periods. The blockchain is continuously monitored in real-time for occurrence of the preferences which triggers the renewal (or blockchain transaction) with optimized blockchain processing (e.g., high availability or performance of processing, network, and/or other resources, etc.). Several blockchain assets may be monitored concurrently to initiate renewals based on corresponding preferences.

Further, the machine learning models may be continuously updated (or trained) based on constantly changing blockchain processing or gas values, blockchain, network and/or other resource conditions, renewals, and/or other attributes. For example, a machine learning model may be continuously updated or trained to adjust the preferences for upper and lower blockchain processing or gas values for a blockchain asset to provide optimized blockchain processing under changing conditions. By way of further example, the risk machine learning model may be continuously updated or trained to adjust the risk for losing the blockchain asset under changing conditions. Thus, the machine learning models may continuously evolve (or be trained) to provide optimized blockchain processing for renewals or risk assessment in constantly changing conditions.

It will be appreciated that the embodiments described above and illustrated in the drawings represent only a few of the many ways of implementing embodiments for renewal of blockchain assets based on optimization of blockchain processing. In addition, characteristics or features of embodiments of the present invention may be combined in any fashion to provide additional embodiments of the present invention.

The environment of the present invention embodiments may include any number of computer or other processing systems (e.g., client or end-user systems, server systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, smart contracts 146, decentralized applications (dApps) 148, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, smart contracts 146, decentralized applications (dApps) 148, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, smart contracts 146, decentralized applications (dApps) 148, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, preferences, renewal information, etc.). The database system may be implemented by any conventional or other databases, data stores or storage structures to store information. The database system may be included within or coupled to the server, client, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., renewal preferences, results of renewal, notifications, overrides, domain or web site content, blockchain asset information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., blockchain assets, renewal status and/or information, renewal preferences, etc.).

The present invention embodiments are not limited to the specific tasks or algorithms described above, but may be utilized for renewing any blockchain assets based on any preferences or conditions for blockchain processing.

A blockchain asset may include any digital asset or item that identifies, is associated with, or includes objects stored on a blockchain (e.g., a set of records, an object that points to a set of records, non-fungible token (NFT), non-fungible token (NFT) or blockchain domain names, a fungible token, a wallet address, etc.). A blockchain domain may be indicated by any name or identifier including any quantity of terms, words, tokens, or arrangements of any quantity of any types of elements (e.g., alphanumeric or other characters, symbols, numbers, etc.). The name or identifier preferably includes a name or identifier portion and an optional extension (e.g., “name.e1”, etc.). The name or identifier portion and extension may each include any quantity of terms, words, tokens, or arrangements of any quantity of any types of elements (e.g., alphanumeric or other characters, symbols, numbers, etc.).

The renewal of a blockchain asset may be at any desired time intervals (e.g., days, weeks, months, years, etc.). The preferences or conditions may include any quantity of any events or conditions for monitoring and triggering renewal of a blockchain asset (e.g., date or time to start monitoring for renewal, blockchain processing values, date or time for immediate renewal (e.g., time interval prior to expiration of the blockchain asset, etc.), renew immediately, defer for better blockchain processing performance, etc.). The preferences may include any attributes identifying blockchain performance for the renewal (e.g., blockchain processing or gas values, time of day for monitoring the blockchain processing, etc.). The preferences may be obtained from a user and/or determined by the system. For example, the system may monitor the blockchain and determine preferences for optimal (high or peak) blockchain processing performance. The preferences may include a range of acceptable blockchain processing or gas values for a time period, a date or time for renewal, etc. The preferences may be determined using a machine learning model. In addition, any quantity of the preferences may be satisfied to initiate the renewal of the blockchain asset.

The preferences may be stored on a blockchain and/or on an off-chain data source. The preferences may be stored and retrieved based on any information (e.g., wallet or blockchain/network address, blockchain asset or user name, etc.). The blockchain assets may be from any desired blockchains, and may be from the same and/or different blockchains.

The estimate may be determined in any manner based on any quantity of any attributes the renewal (e.g., renewal fees, blockchain processing or gas values, etc.). Any suitable actions may be performed to enable compliance with or override the preferences or conditions. For example, a notification may be sent to the user providing information pertaining to the renewal (e.g., difference between current blockchain processing or gas values and the preferences or conditions, risk of losing the blockchain asset by not renewing, recommendations pertaining to immediate renewal or deferred renewal, etc.). The risk may be determined based on any attributes or analytics for blockchain processing. By way of example, the risk may be determined by a machine learning model. The preferences may be overridden based on the information. Further, the renewal may be delayed by a specified or predetermined time interval.

Having described preferred embodiments of a new and improved system, method, and computer program product for renewal of blockchain assets based on optimization of blockchain processing, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of renewing a blockchain asset comprising:
monitoring, via at least one processor, for a set of conditions associated with renewal of the blockchain asset, wherein the set of conditions controls renewal processing and includes one or more blockchain processing values for performance of the renewal on a blockchain; and
renewing, via the at least one processor, the blockchain asset on the blockchain in response to satisfaction of the set of conditions.

2. The method of claim 1, wherein the blockchain asset includes one from a group of a blockchain domain name and a non-fungible token, and the one or more blockchain processing values include gas.

3. The method of claim 1, further comprising:
determining upper and lower blockchain processing values for a time period for the set of conditions via a machine learning model of the at least one processor.

4. The method of claim 1, wherein renewing the blockchain asset comprises:
determining an estimate for renewing the blockchain asset; and
renewing the blockchain asset in response to the estimate satisfying the set of conditions.

5. The method of claim 4, further comprising:
in response to the estimate failing to satisfy the set of conditions:
providing, via the at least one processor, a notification including information pertaining to renewal of the blockchain asset; and
renewing, via the at least one processor, the blockchain asset based on an override of the set of conditions.

6. The method of claim 5, wherein the notification includes one or more from a group of: a difference between current blockchain processing values and the one or more blockchain processing values of the set of conditions, and a risk associated with losing the blockchain asset due to deferral of renewal of the blockchain asset until satisfaction of the set of conditions.

7. The method of claim 1, further comprising:
renewing, via the at least one processor, the blockchain asset on the blockchain in response to being within a time interval of expiration of the blockchain asset, wherein the time interval overrides the set of conditions.

8. The method of claim 1, wherein renewing the blockchain asset comprises:
determining an estimate for renewing the blockchain asset; and
delaying renewal of the blockchain asset for a time period in response to the estimate failing to satisfy the set of conditions.

9. A system for renewing a blockchain asset comprising:
one or more memories; and
at least one processor coupled to the one or more memories, the at least one processor configured to:
monitor for a set of conditions associated with renewal of the blockchain asset, wherein the set of conditions controls renewal processing and includes one or more blockchain processing values for performance of the renewal on a blockchain; and
renew the blockchain asset on the blockchain in response to satisfaction of the set of conditions.

10. The system of claim 9, wherein the blockchain asset includes one from a group of a blockchain domain name and a non-fungible token, and the one or more blockchain processing values include gas.

11. The system of claim 9, wherein the at least one processor is further configured to:
determine upper and lower blockchain processing values for a time period for the set of conditions via a machine learning model.

12. The system of claim 9, wherein renewing the blockchain asset comprises:
determining an estimate for renewing the blockchain asset; and
renewing the blockchain asset in response to the estimate satisfying the set of conditions.

13. The system of claim 12, wherein the at least one processor is further configured to:
in response to the estimate failing to satisfy the set of conditions:
provide a notification including information pertaining to renewal of the blockchain asset; and
renew the blockchain asset based on an override of the set of conditions.

14. The system of claim 13, wherein the notification includes one or more from a group of: a difference between current blockchain processing values and the one or more blockchain processing values of the set of conditions, and a risk associated with losing the blockchain asset due to deferral of renewal of the blockchain asset until satisfaction of the set of conditions.

15. The system of claim 9, wherein the at least one processor is further configured to:
renew the blockchain asset on the blockchain in response to being within a time interval of expiration of the blockchain asset, wherein the time interval overrides the set of conditions.

16. The system of claim 9, wherein renewing the blockchain asset comprises:
determining an estimate for renewing the blockchain asset; and
delaying renewal of the blockchain asset for a time period in response to the estimate failing to satisfy the set of conditions.

17. A computer program product for renewing a blockchain asset, the computer program product comprising one or more computer readable media having instructions stored thereon, the instructions executable by at least one processor to cause the at least one processor to:
monitor for a set of conditions associated with renewal of the blockchain asset, wherein the set of conditions controls renewal processing and includes one or more blockchain processing values for performance of the renewal on a blockchain; and
renew the blockchain asset on the blockchain in response to satisfaction of the set of conditions.

18. The computer program product of claim 17, wherein the blockchain asset includes one from a group of a blockchain domain name and a non-fungible token, and the one or more blockchain processing values include gas.

19. The computer program product of claim 17, wherein the instructions further cause the at least one processor to:
determine upper and lower blockchain processing values for a time period for the set of conditions via a machine learning model.

20. The computer program product of claim 17, wherein renewing the blockchain asset comprises:
determining an estimate for renewing the blockchain asset; and
renewing the blockchain asset in response to the estimate satisfying the set of conditions.

21. The computer program product of claim 20, wherein the instructions further cause the at least one processor to:
in response to the estimate failing to satisfy the set of conditions:
provide a notification including information pertaining to renewal of the blockchain asset; and
renew the blockchain asset based on an override of the set of conditions.

22. The computer program product of claim 21, wherein the notification includes one or more from a group of: a difference between current blockchain processing values and the one or more blockchain processing values of the set of conditions, and a risk associated with losing the blockchain asset due to deferral of renewal of the blockchain asset until satisfaction of the set of conditions.

23. The computer program product of claim 17, wherein the instructions further cause the at least one processor to:
renew the blockchain asset on the blockchain in response to being within a time interval of expiration of the blockchain asset, wherein the time interval overrides the set of conditions.

24. The computer program product of claim 17, wherein renewing the blockchain asset comprises:
determining an estimate for renewing the blockchain asset; and
delaying renewal of the blockchain asset for a time period in response to the estimate failing to satisfy the set of conditions.
